(19) United States
(12) Patent Application Publication
(10) Pub. No.: US 2018/0035200 A1
(43) Pub. Date: Feb. 1, 2018

(54) VIBRATION TRANSFER STRUCTURE AND PIEZOELECTRIC SPEAKER

(71) Applicant: TOKIN Corporation, Sendai-shi, Miyagi (JP)

(72) Inventors: Yoshiyuki ABE, Sendai-shi, Miyagi (JP); Masafumi KATSUNO, Sendai-shi, Miyagi (JP); Koichi SHUTA, Sendai-shi, Miyagi (JP); Osamu YAMAZAKl, Sendai-shi, Miyagi (JP); Noriaki IKEZAWA, Sendai-shi, Miyagi (JP); Katsunori KUMASAKA, Sendai-shi, Miyagi (JP)

(21) Appl. No.: 15/549,240

(22) PCT Filed: Mar. 17, 2016
(86) PCT No.: PCT/JP2016/001530

§ 371 Date: Aug. 7, 2017

(30) Foreign Application Priority Data
Aug. 20, 2015 (JP) 2015-162759

(51) Int. Cl. H04R 1/28; H04R 17/00; H04R 1/30; H04R 7/04

(52) U.S. Cl. CPC H04R 1/2811; H04R 7/04; H04R 17/00; H04R 1/30

(57) ABSTRACT

A vibration transfer structure (300) and a piezoelectric speaker (400) capable of achieving excellent vibration characteristics even when a piezoelectric device (1) is used. A vibration transfer structure (300) according to an aspect of the present disclosure includes a plate-like piezoelectric device (1) supported at both ends thereof, a diaphragm (3) disposed to be opposed to the piezoelectric device (1), a plurality of spacers (5) configured to connect the piezoelectric device (1) with the diaphragm (3), and an elastic body (24) disposed on a periphery (3a) of the diaphragm (3).

### TECHNICAL FIELD

The present disclosure relates to a vibration transfer structure and a piezoelectric speaker.

### BACKGROUND ART

As examples of speakers that convert electric signals into vibrations (acoustic signals), there are electromagnetic speakers and piezoelectric speakers. Patent Literature 1 discloses a piezoelectric speaker. The piezoelectric speaker disclosed in Patent Literature 1 includes a piezoelectric device that vibrates when an electric signal is applied thereto, and a vibrating body to which the piezoelectric device is joined with a joining material interposed therebetween.

Specifically, the piezoelectric device expands/contracts as a voltage is applied to the piezoelectric device. Further, as the piezoelectric device expands/contracts, the plate-like vibrating body is warped. In this way, the piezoelectric speaker produces a sound by the warping motion.

### CITATION LIST

### Patent Literature

Patent Literature 1: International Patent Publication No. W02014/045645

### SUMMARY OF INVENTION

### Technical Problem

According to a sound pressure calculation formula for an electromagnetic speaker, a sound pressure (Pa) depends on the product of the size of a diaphragm and its vibrating speed.

Specifically, the sound pressure (Pa) is expressed by the below-shown Expression (1).

Sound pressure (Pa)=
(Air density)×(Diaphragm size)×(Vibrating speed)×(Frequency/21/2)/Distance from microphone) (1)

Based on “(Diaphragm size)×(Vibrating speed)”, it can be understood that as a precondition, the entire area of the diaphragm is made to perform piston motion (linear vibrations). Further, in view of Expression (1), it can be understood that when warping is used, the speed, i.e., the sound pressure relatively decreases. Further, due to the warping motion, second-order mode and third-order mode vibrations occur. From the acoustic viewpoint, harmonic distortions cause degradation in sound.

The piezoelectric device has a d33 mode and a d31 mode. In the d33 mode, the piezoelectric device expands/contracts perpendicularly to an electrode surface (i.e., in the thickness direction of the electrode surface). In the d31 mode, the piezoelectric device expands/contracts in a direction parallel to the electrode surface. In the d33 mode, amplitudes in non-resonance frequencies are in the order of nanometers or smaller, and thus it is not suitable for acoustic purposes in which a playback in a wide-band is required.

For the acoustic purposes, amplitudes of at least several tens of micrometers are required. In the d31 mode (bimorph/unimorph), it is possible to obtain amplitudes of several tens of micrometers or larger even in the non-resonance frequencies. In the d31 mode, vibrations are warping vibrations. Therefore, in a piezoelectric speaker, it is very difficult to make the diaphragm perform piston motion (linear motion) with excellent characteristics. For example, it is very difficult to produce a high sound pressure in a wide-band.

The present disclosure provides a vibration transfer structure and a piezoelectric speaker capable of achieving excellent vibration characteristics even when a piezoelectric device is used.

### Solution to Problem

A vibration transfer structure according to an aspect of the present disclosure includes: a plate-like piezoelectric device supported at both ends thereof; a diaphragm disposed to be opposed to the piezoelectric device; a plurality of spacers configured to connect the diaphragm with the piezoelectric device; and an elastic body disposed on a periphery of the diaphragm.

A vibration transfer structure according to an aspect of the present disclosure includes: a plate-like piezoelectric device supported at both ends thereof; an elastic body disposed to be opposed to the piezoelectric device; a diaphragm disposed on a surface of the elastic body opposite to a side on which the piezoelectric device is located; and a plurality of spacers disposed between the piezoelectric device and the elastic body, the plurality of spacers being adapted to transfer a vibration between the piezoelectric device and the elastic body.

In the above-described vibration transfer structure, the plurality of spacers may be disposed in places that are deviated from a center of the piezoelectric device.

In the above-described vibration transfer structure, the plurality of spacers may include a first spacer disposed between a center of the piezoelectric device and one of the supported ends of the piezoelectric device, and a second spacer disposed between the center of the piezoelectric device and the other supported end of the piezoelectric device.

In the above-described vibration transfer structure, the plurality of spacers may be plate-like members disposed along the supported ends of the piezoelectric device.

A piezoelectric speaker according to an aspect of the present disclosure includes: the above-described vibration transfer structure; a housing configured to accommodate the vibration transfer structure; and a cover with a sound emitting hole having a horn shape formed therein, the cover being configured to cover the housing, in which the diaphragm is disposed so as to overlap the sound emitting hole.

The above-described piezoelectric speaker may include a plurality of vibration transfer structures and a plurality of sound emitting holes, and the plurality of vibration transfer structures may be accommodated in the housing.

### Advantageous Effects of Invention

According to the present disclosure, it is possible to provide a vibration transfer structure and a piezoelectric speaker capable of achieving excellent vibration characteristics even when a piezoelectric device is used.

### BRIEF DESCRIPTION OF DRAWINGS

FIG. 1 is a perspective view showing a structure of a vibration transfer structure according to a first embodiment;

FIG. 2 is an image showing a vibration of the vibration transfer structure according to the first embodiment;

FIG. 3 is an image showing a vibration of the vibration transfer structure according to the first embodiment;

FIG. 4 is a graph showing sound pressure versus frequency;

FIG. 5 is a graph showing sound pressure versus frequency;

FIG. 6 is a bottom view of main parts of a piezoelectric speaker according to a second embodiment;

FIG. 7 is a diagram for explaining an arrangement of spacers;

FIG. 8 is a perspective view showing a structure of a vibration transfer structure according to a third embodiment;

FIG. 9 shows a piezoelectric speaker using the vibration transfer structure shown in FIG. 8; and

FIG. 10 is a perspective view schematically showing an internal structure of a piezoelectric speaker.

### Description of Embodiments

A vibration transfer structure according to this embodiment is suitable for a piezoelectric speaker. Therefore, this embodiment is explained by using a piezoelectric speaker as an example of the vibration transfer structure. However, the vibration transfer structure according to this embodiment can also be applied to a wide-band transducer or the like as well as an acoustic piezoelectric device.

### First Embodiment

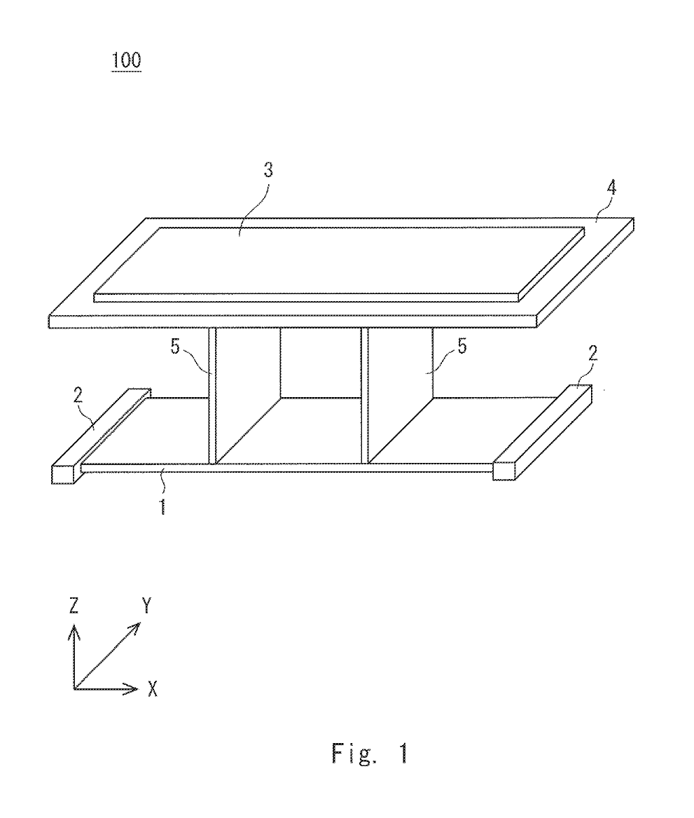

A vibration transfer structure 100 according to a first embodiment is explained with reference to FIG. 1. FIG. 1 is a perspective view showing the vibration transfer structure 100 according to the first embodiment. The vibration transfer structure 100 includes a piezoelectric device 1, support parts 2, a diaphragm 3, an elastic body 4, and spacers 5.

For clarifying the following explanation, a three-dimensional orthogonal coordinate system shown in FIG. 1 is used. The Z-direction is the thickness direction of the diaphragm 3. The X-and Y-directions are directions that are parallel or perpendicular to the sides of the rectangular diaphragm 3. Further, in the following explanation, the positive side in the Z-direction, i.e., the side of the surface from which a sound is emitted is the front surface side.

The piezoelectric device 1 is an actuator that converts electric energy into mechanical energy. In this example, a piezoelectric bimorph is used as the piezoelectric device 1. However, a piezoelectric unimorph can also be used. The piezoelectric device 1 has a plate-line shape whose thickness direction is parallel to the Z-direction. The piezoelectric device 1 has a rectangular shape in a XY-plane view. The X-direction is parallel to the long-side direction of the piezoelectric device 1 and the Y-direction is parallel to the short-side direction of the piezoelectric device 1.

The support parts 2 are disposed on both ends of the piezoelectric device 1. The support parts 2 support the piezoelectric device 1. Specifically, the piezoelectric device 1 is fixed to a frame or the like (not shown) through the support parts 2. For example, both ends of the piezoelectric device 1 are stuck to the frame by using double-faced tape or an adhesive.

As described above, the piezoelectric device 1 is supported at both ends thereof. In this example, the piezoelectric device 1 is supported at both ends in the X-direction through the support parts 2. That is, the two support parts 2 are arranged with an interval therebetween in the long-side direction of the piezoelectric device 1. Each of the support parts 2 is disposed so as to extend along the Y-direction. In this example, each of the support parts 2 is disposed over the entire side of the piezoelectric device 1 that extends in the Y-direction. Except for both ends, the piezoelectric device 1 is not restrained.

The elastic body 4 is disposed on the front surface side of the piezoelectric device 1, which is supported at both ends. The elastic body 4 has a plate-like shape parallel to the piezoelectric device 1. The elastic body 4 is disposed to be opposed to the piezoelectric device 1. The elastic body 4 and the piezoelectric device 1 have shapes substantially identical to each other in the XY-plane view. Specifically, the elastic body 4 has a rectangular shape having roughly the same size as that of the piezoelectric device 1. Further, the elastic body 4 and the piezoelectric device 1 are disposed to be opposed to each other with the spacers 5 interposed therebetween.

The diaphragm 3 is disposed on the front surface of the elastic body 4. The diaphragm 3 is, for example, a metal shim The diaphragm 3 has a plate-like shape parallel to the elastic body 4. The diaphragm 3 has a rectangular shape and is slightly smaller than the elastic body 4 in the XY-plane view. The diaphragm 3 is joined to the front surface of the elastic body 4. Specifically, the periphery of the diaphragm 3 is stuck to the front surface of the diaphragm 3 by using double-faced tape or the like. In this way, the diaphragm 3 is held through the elastic body 4. Therefore, the diaphragm 3 can be held in a flexible manner.

Further, the plurality of spacers 5 are interposed between the elastic body 4 and the piezoelectric device 1. That is, one end of each of the spacers 5 is attached to the rear surface of the elastic body 4 and the other end of each of the spacers 5 is attached to the front surface of the piezoelectric device 1. In this way, the diaphragm 3 and the piezoelectric device 1 are disposed to be opposed to each other with an interval therebetween in the Z-direction. Although two spacers 5 are disposed in FIG. 1, the number of spacers 5 is not limited to any particular number. At least two spacers 5 should be disposed. Therefore, three or more spacers 5 may be disposed between the piezoelectric device 1 and the elastic body 4. The spacers 5 are disposed between the piezoelectric device 1 and the elastic body 4. The plurality of spacers 5 transfer vibrations between the piezoelectric device 1 and the elastic body 4.

The plurality of spacers 5 are arranged with an interval therebetween in the X-direction. The plurality of spacers 5 are disposed in places that are deviated from the center of the piezoelectric device 1. That is, they are disposed so as to avoid transferring vibrations at the center of the piezoelectric device 1 where the amplitude (the sound pressure) is the largest. Specifically, one of the two spacers 5 is deviated from the center of the piezoelectric device 1 toward the positive side in the X-direction and the other spacer 5 is deviated from the center of the piezoelectric device 1 toward the negative side in the X-direction. Therefore, one of the spacers 5 is disposed between the center of the piezoelectric device 1 and one of the support parts 2, and the other spacer 5 is disposed between the center of the piezoelectric device 1 and the other support part 2. The plurality of spacers 5 may be arranged in a symmetric manner in the XY-plane view. For example, in FIG. 1, the two spacers 5 are line-symmetric with respect to a straight line that extends in the Y-direction and passes through the center of the piezoelectric device 1.

In FIG. 1, each of the spacers 5 has a rectangular plate shape whose thickness direction is parallel to the X-direction. Further, the two plate-like spacers 5 are arranged parallel to the YZ-plane. That is, each of the spacers 5 is a plate-like member disposed along the supported end of the piezoelectric device 1. The sizes of the two spacers 5 are roughly the same as each other. The length of the spacer 5 in the Y-direction is roughly the same as the length of the piezoelectric device 1. Note that the shape of the spacer 5 is not limited to any particular shape. For example, a resin such as Teflon (Registered Trademark) can be used for the spacer 5.

As described above, the piezoelectric device 1 is connected to the diaphragm 3 with the spacers 5 interposed therebetween. As an electric signal is applied to the piezoelectric device 1, the piezoelectric device 1 expands/contracts. In this example, the piezoelectric device 1 operates in the d31 mode. Vibrations generated by the expansion/contraction of the piezoelectric device 1 propagate to the elastic body 4 through the spacers 5. As a result, the diaphragm 3 stuck to the elastic body 4 vibrates. A sound is output by the vibrations of the diaphragm 3. Therefore, the vibration transfer structure 100 works as a piezoelectric speaker.

As described above, when vibrations of the piezoelectric device 1 propagate to the diaphragm 3, the warping motion of the piezoelectric device 1 is converted into piston motion (linear motion) in the Z-direction by the spacers 5. In this way, it is possible to increase the sound pressure and enable vibrations in a wide-band.

Advantageous effects in this embodiment are explained hereinafter in comparison to those in a comparative example In the comparative example, a structure in which a piezoelectric bimorph or a piezoelectric unimorph is simply joined to a diaphragm is used as a piezoelectric speaker. In the structure of the comparative example, a mechanical quality coefficient Qm of the bimorph or the unimorph is roughly equal to a mechanical quality coefficient of the diaphragm. Therefore, although it is possible to increase the sound pressure in the structure of the comparative example, this structure is not suitable for a speaker in which a playback in a wide-band is required.

Therefore, in this embodiment, the elastic body 4 and the piezoelectric device 1 are disposed to be opposite to each other with the spacers 5 interposed therebetween. That is, in order to increase the sound pressure and decrease the mechanical quality coefficient Qm, the plurality of spacers 5 are disposed between the diaphragm 3 and piezoelectric device 1. By doing so, the warping motion of the piezoelectric device 1 is converted into piston motion (linear motion) parallel to the Z-direction. Therefore, it is possible to produce a high sound pressure in a wide-band. Consequently, it is possible to achieve excellent vibration characteristics.

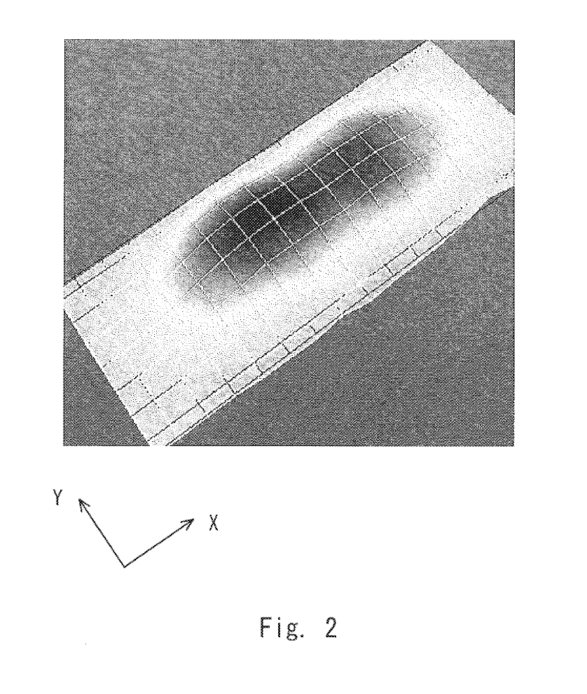

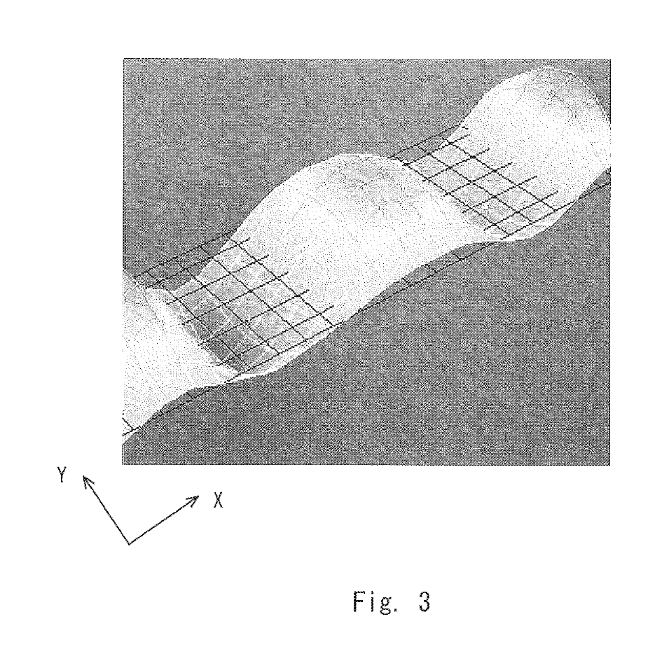

FIGS. 2 and 3 show results of measurement of vibrations in a piezoelectric speaker according to an example and a piezoelectric speaker according to a comparative example. In the example, the vibration transfer structure 100 shown in FIG. 1 was used as the piezoelectric speaker. In the comparative example, the structure in which a piezoelectric bimorph is stuck to a diaphragm as described above was used. FIGS. 2 and 3 show three-dimensional (3D) images obtained by measuring vibrations of the elastic body 4 by using a scanning vibrometer. FIGS. 2 and 3 show measurement results in the example and the comparative example, respectively.

When FIGS. 2 and 3 are compared to each other, it can be understood that the motion of the diaphragm 3 in the example is closer to piston motion (linear motion) than the motion in the comparative example is. That is, the vibrations of the diaphragm 3 in the example are more uniform in the XY-plane. In contrast to this, the motion in the comparative example is closer to warping motion and hence the diaphragm 3 is undulating as shown in FIG. 3.

Next, frequency characteristics of the piezoelectric speakers according to the example and the comparative example are explained. Note that the same piezoelectric device was used in both the example and the comparative example. Specifically, a piezoelectric bimorph having a rectangular shape of 23 mm×3.3 mm was used. Further, the thickness of the piezoelectric device was 1.1 mm. Further, the capacitance of the piezoelectric device 1 was 1.2 μF.

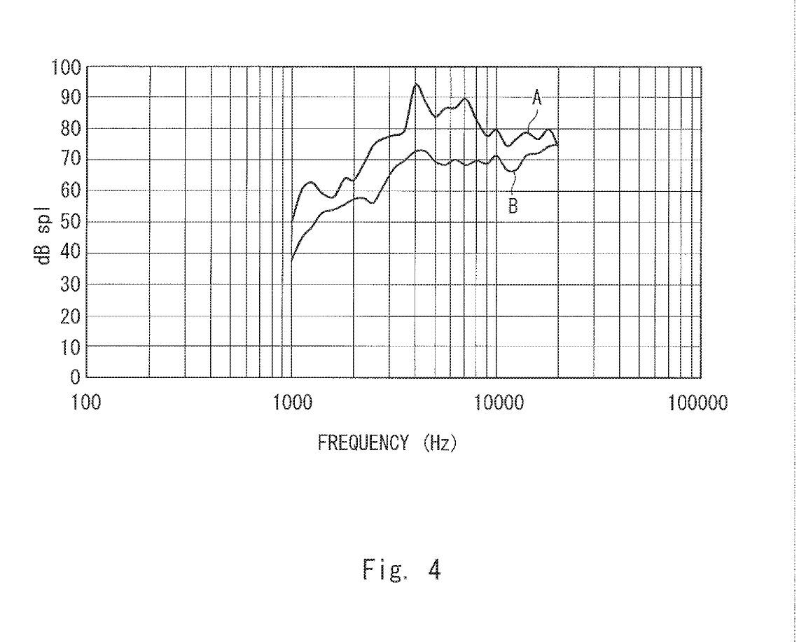

FIG. 4 is a graph showing results of measurement of a sound pressure frequency characteristic. In FIG. 4, A and B represent sound pressure frequency characteristics in the example and the comparative example, respectively.

The sound pressure in the example is higher than that in the comparative example at all the frequencies. Specifically, the sound pressure in the example is higher than that in the comparative example by 10 dB or more. This means that a high sound pressure can be output in a wide-band. According to this embodiment, it is possible to achieve an excellent frequency characteristic.

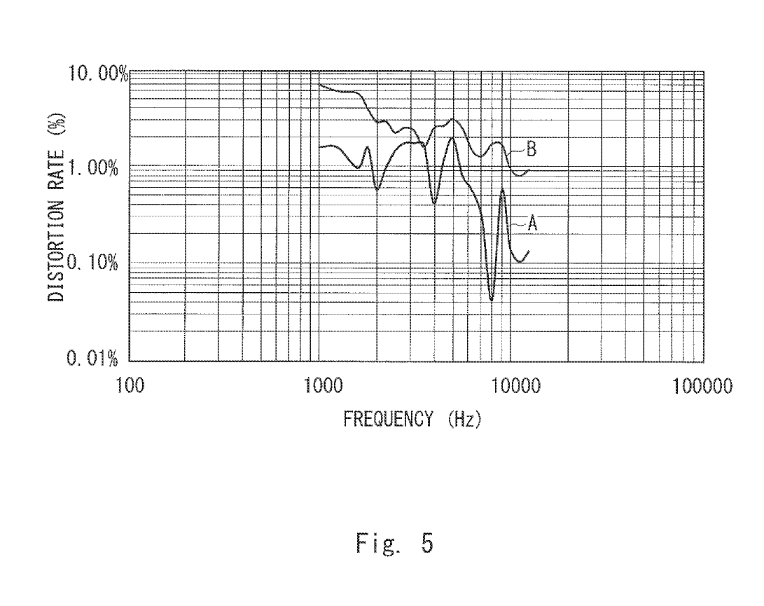

FIG. 5 shows results of measurement of a distortion rate in a piezoelectric speaker. In FIG. 5, A and B represent distortion rates in the example and the comparative example, respectively. Note that FIG. 5 shows results of measurement of a total harmonic distortion rate from 1 kHz to 10 kHz. Specifically, a sine wave having a frequency of 1 kHz is applied to a test element and its response is measured. Depending on the nonlinearity of the test element itself, “(Response at 1 kHz)+(Response at 2 kHz)+(Response at 3 kHz)+. . . .” is obtained. Note that the following are defined: (Physical quantity of response at 2 kHz)/(Physical quantity of response at 1 kHz)=Second-order distortion rate; and (Physical quantity of response at 3 kHz)/(Physical quantity of response at 1 kHz)=Third-order distortion rate. Further, the following is defined: Root-mean-square of harmonic distortion from 1 kHz to 10 kHz=Total Harmonic Distortion (T.H.D)

As shown in FIG. 5, the distortion rate in the example is lower than that in the comparative example. Specifically, the harmonic distortion in the example is lower than that in the comparative example by an order of magnitude.

As described above, according to the piezoelectric speaker including the vibration transfer structure 100 having the above-described structure, it is possible to achieve a high sound pressure and a low distortion rate.

### Second Embodiment

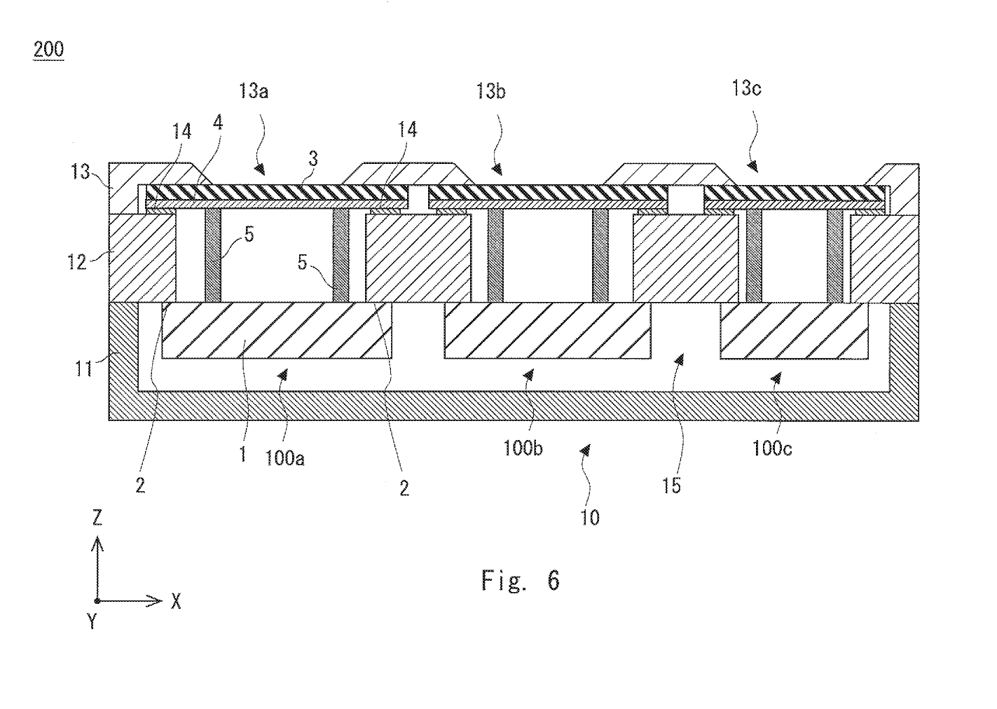

A piezoelectric speaker 200 according to this embodiment is explained with reference to FIG. 6. FIG. 6 is a cross section schematically showing a structure of the piezoelectric speaker 200. In this embodiment, three vibration transfer structures 100 each of which has the structure shown in FIG. 1 described in the first embodiment are used. Hereinafter, these vibration transfer structures 100, each of which has the structure shown in FIG. 1, are referred to as vibration transfer structures 100a, 100b and 100c, respectively. Note that the structure of each of the vibration transfer structures 100a to 100c is similar to that in the first embodiment and therefore its explanation is omitted.

Further, in this embodiment, the three vibration transfer structures 100a to 100c are accommodated inside a case 10. The case 10 includes a housing 11, a frame 12, and a cover 13.

A housing 6 has a box shape and its face that is parallel to the XY-plane and located on the positive side in the Z-direction is opened. That is, the housing 6 is a rectangular parallelepiped box with one opened face. Further, the cover 13 covers the opened face of the housing 11. The cover 13 is attached to the housing 11 with the frame 12 interposed therebetween. That is, the frame 12 is disposed between the cover 13 and the housing 11. The frame 12 is attached to the housing 11. The cover 13 is attached to the frame 12. For example, a metal material such as aluminum can be used for the housing 11. Needless to say, a resin material such as acryl can also be used for the housing 11. For example, the frame 12 is preferably a rigid body having a thickness of 1 mm.

The three vibration transfer structures 100a to 100c are disposed in an internal space 15 formed by the housing 11, the cover 13, and the frame 12. The vibration transfer structures 100a to 100c have different sizes from each other. Specifically, their lengths in the X-direction differ from each other. Therefore, the vibration transfer structures 100a to 100c have different frequency characteristics. By providing the vibration transfer structures 100a to 100c having different sizes, they can complement each other's characteristics. In FIG. 6, the vibration transfer structure 100a is the largest and the vibration transfer structure 100c is the smallest.

Sound emitting holes 13a to 13c are formed in the cover 13. Note that in the cover 13, the three sound emitting holes 13a to 13c are provided so as to correspond to the three vibration transfer structures 100a to 100c, respectively. Vibrations of the vibration transfer structure 100a are output to the outside through the sound emitting hole 13a. Vibrations of the vibration transfer structure 100b are output to the outside through the sound emitting hole 13b. Vibrations of the vibration transfer structure 100c are output to the outside through the sound emitting hole 13c.

Since the vibration transfer structures 100a to 100c have different sizes, the sound emitting holes 13a to 13c have different sizes, too. The sound emitting hole corresponding to the vibration transfer structure 100a is the largest and the cover 13c corresponding the vibration transfer structure 100c is the smallest. The sound emitting holes 13a to 13c have, for example, rectangular shapes corresponding to the sizes of the vibration transfer structures 100a to 100c, respectively.

Each of the sound emitting holes 13a to 13c has a horn shape. That is, the size of the hole (the opening) of each of the sound emitting holes 13a to 13c gradually decreases from the outer side of the case 10 toward the inner side thereof. Therefore, the parts of the cover 13 that adjoin the sound emitting holes 13a to 13c have tapered shapes (inclined surfaces).

Each of the vibration transfer structures 100a to 100c has the structure shown in FIG. 1. That is, the vibration transfer structures 100a to 100c are fixed to the case 10 by using similar attaching structures. The following explanation is given with particular emphasis on the structure of the vibration transfer structure 100a.

Both ends of the piezoelectric device 1 are formed as support parts 2 supported by the frame 12. For example, both ends of the piezoelectric device 1 are stuck to the frame 12 by using double-faced tape. In this way, the frame 12 supports the piezoelectric device 1 at both ends thereof. The width of the support part 2 is about 1 mm For example, the frame 12 and the piezoelectric device 1 are stuck to each other by disposing double-faced tape having a width of about 1 mm between the piezoelectric device 1 and the frame 12. Except for the support parts 2, the piezoelectric device 1 is not adhered to the frame 12. An opening is formed in the frame 12 so that the piezoelectric device 1 is not restrained except for both ends thereof.

As described above, the piezoelectric device 1 is connected to the elastic body 4 with the spacers 5 interposed therebetween. The elastic body 4 and the piezoelectric device 1 are disposed to be opposed to each other. The diaphragm 3 is disposed on the front surface side of the elastic body 4. The diaphragm 3 is disposed on the rear surface side of the cover 13. Further, the diaphragm 3 can be viewed from the outside through the sound emitting hole 13a. That is, the diaphragm 3 overlaps the sound emitting hole 13a of the cover 13 in the XY-plane view

Further, the cover 13 covers the periphery of the diaphragm 3. That is, the sound emitting hole 13a is a size smaller than the diaphragm 3. Therefore, the periphery of the diaphragm 3 overlaps the cover 13.

The periphery of the diaphragm 3 is fixed to the frame 12 by a fixing material 14. The fixing material 14 can be, for example, double-faced tape having a width of about 1 mm. Further, the fixing material 14 bonds the front surface of the frame 12 to the rear surface of the diaphragm 3.

By the above-described structure, it is possible to provide the piezoelectric speaker 200 having excellent characteristics. Note that although three vibration transfer structures 100a to 100c are disposed in the case 10 in the above-described embodiment, the number of vibration transfer structures 100 is not limited to any particular number. At least one vibration transfer structure 100 should be disposed in the case 10. Alternatively, more than one vibration transfer structure 100 may be disposed in the case 10. When a plurality of vibration transfer structures 100 are disposed in the case 10, those vibration transfer structures 100 may have different sizes from one another.

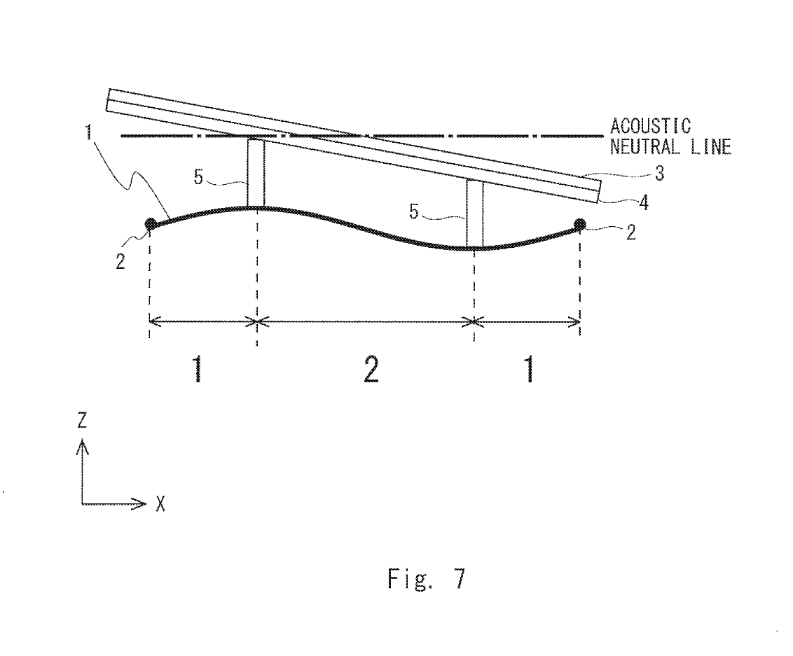

Further, harmonic distortions can be reduced by adjusting the places in which the spacers 5 are attached. For example, the spacers 5 are preferably disposed in places where the amplitude is maximized when the rectangular piezoelectric device 1 operates in a second-order mode. Specifically, as shown in FIG. 7, they are disposed so as to satisfy the following relation: (Distance from one end of piezoelectric device 1 to one of spacers 5):(Distance between two spacers 5):(Distance from other end of piezoelectric device 1 to other spacer 5)=1:2:1. By disposing the spacers 5 in the places where the amplitude is maximized in the second-order mode, the amplitude of the second-order mode can be cancelled out. The reason for this is explained hereinafter.

When a rectangular piezoelectric device 1 is used, there is a tendency that a harmonic distortion could occur at a certain frequency. For example, when a sine wave having a frequency of 100 kHz is applied and a second-order mode is present at 2 kHz, the diaphragm 3 will operate at 1 kHz and 2 kHz as its bending motion due to the nonlinearity of the rectangular piezoelectric device 1. The motion at 2 kHz becomes a harmonic distortion and hence becomes the main cause of degradation in sound.

Therefore, in this embodiment, in order to reduce the harmonic distortion and thereby improve the sound as well as increasing the sound pressure, the spacers 5 are disposed so that the diaphragm is prevented from performing acoustic motion in the second-order and third-order modes. Specifically, the spacers 5 are disposed in such places that even when the diaphragm 3 vibrates, the vibrations can be relatively cancelled out in regard to the sound pressure.

Therefore, the spacers 5 are disposed as shown in FIG. 7. In FIG. 7, since the piezoelectric device 1 is warped, the diaphragm 3 is inclined. When the diaphragm 3 is inclined, it looks as if a sound is produced. However, the diaphragm 3 is inclined across an acoustic neutral line. Therefore, the sound pressure caused by the incline on the right side of the diaphragm 3 and that on the left side of the diaphragm 3 are cancelled out. As a result, no sound is produced. That is, it is possible to prevent the second-order harmonic from being output.

Since the second-order mode is not used, the piezoelectric device 1 does not operate as a wide-band speaker (or a broadband speaker). However, by using a plurality of vibration transfer structures 100 as shown in FIG. 6, it is possible to make the piezoelectric device 1 operate as a wide-band speaker. That is, by using a plurality of vibration transfer structures 100, it is possible to connect them in a multistage manner while shifting their resonant frequencies in the first-order mode from one another.

### Third Embodiment

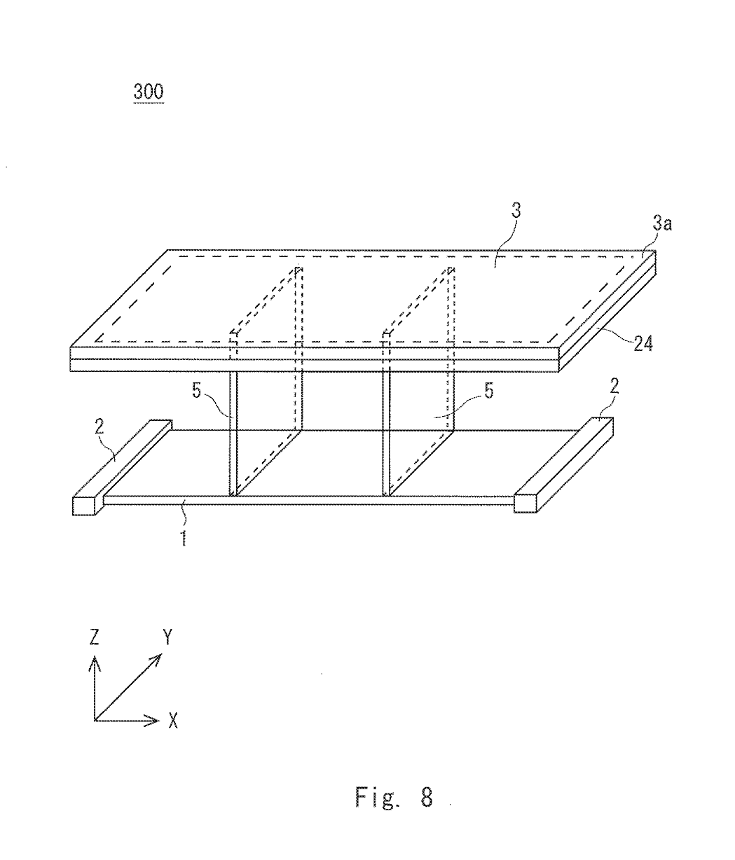

A vibration transfer structure 300 according to this embodiment is explained with reference to FIG. 8. FIG. 8 is a perspective view schematically showing a structure of the vibration transfer structure 300 according to a third embodiment. The structure according to this embodiment differs from that according to the first embodiment in the structure of the elastic body 4. Specifically, an elastic body 24 is provided in place of the elastic body 4 shown in FIG. 1. Note that the fundamental structure of the vibration transfer structure 300 except for the elastic body 24 is similar to that of the vibration transfer structure 100 according to the first embodiment and therefore its explanation is omitted as appropriate.

Specifically, the elastic body 24 is formed in a frame shape. That is, a rectangular opening is formed in the central part of the elastic body 24. The elastic body 24 is formed in the rectangular frame shape so that it is disposed to be opposed to the peripheral 3a of the diaphragm 3. Further, the elastic body 24 is attached only to the peripheral 3a of the diaphragm 3. Therefore, the elastic body 24 is not disposed in the central part of the diaphragm 3 located inside the peripheral 3a thereof. Further, the elastic body 24 functions as a fixing material that fixes the diaphragm 3 to a frame (not shown). The elastic body 24 is, for example, elastic double-faced tape. The elastic body 24 is formed so that is does not protrude beyond the edge of the diaphragm 3.

The spacers 5 are attached to the diaphragm 3 through the opening of the elastic body 24 having the rectangular frame shape. Therefore, the spacers 5 are directly fixed to the diaphragm 3. The spacers 5 are attached to the diaphragm 3 without the elastic body 24 being interposed therebetween. In other words, one of the ends of each spacer 5 in the Z-direction is attached to the diaphragm 3 and the other end of the spacer 5 is attached to the piezoelectric device 1. As described above, the piezoelectric device 1 and the diaphragm 3 are connected to each other with the spacers 5 interposed therebetween. In FIG. 8, two spacers 5 are interposed between the piezoelectric device 1 and the diaphragm 3.

The support parts 2 support the plate-like piezoelectric device 1 at both ends thereof. The piezoelectric device 1 is disposed to be opposed to the diaphragm 3. Further, since the spacers 5 are disposed between the piezoelectric device 1 and the diaphragm 3, the piezoelectric device 1 and the diaphragm 3 are disposed to be opposed to each other with an interval equivalent to the length of the spacers 5 therebetween. Similarly to the first embodiment, the spacers 5 are disposed in places that are deviated from the center of the piezoelectric device 1 in the X-direction. Specifically, one of the spacers 5 is disposed between the center of the piezoelectric device 1 and one of the supported ends of the piezoelectric device 11, and the other spacer 5 is disposed between the center of the piezoelectric device 1 and the other supported end of the piezoelectric device 1. Each of the spacers 5 is a plate-like member disposed along the supported end of the piezoelectric device 1.

As an electric signal is applied to the piezoelectric device 1, the piezoelectric device 1 expands/contracts. In this example, the piezoelectric device 1 operates in the d31 mode. Vibrations generated by the expansion/contraction of the piezoelectric device 1 propagate to the elastic body 4 through the spacers 5. As a result, the diaphragm 3 stuck to the elastic body 4 vibrates. A sound is output by the vibrations of the diaphragm 3. Therefore, the vibration transfer structure 100 works as a piezoelectric speaker.

As described above, when vibrations of the piezoelectric device 1 propagate to the diaphragm 3, the warping motion of the piezoelectric device 1 is converted into piston motion (linear motion) in the Z-direction by the spacers 5. In this way, it is possible to increase the sound pressure and enable vibrations in a wide-band. By the above-described structure, it is also possible to achieve excellent vibration characteristics as in the case of the first embodiment.

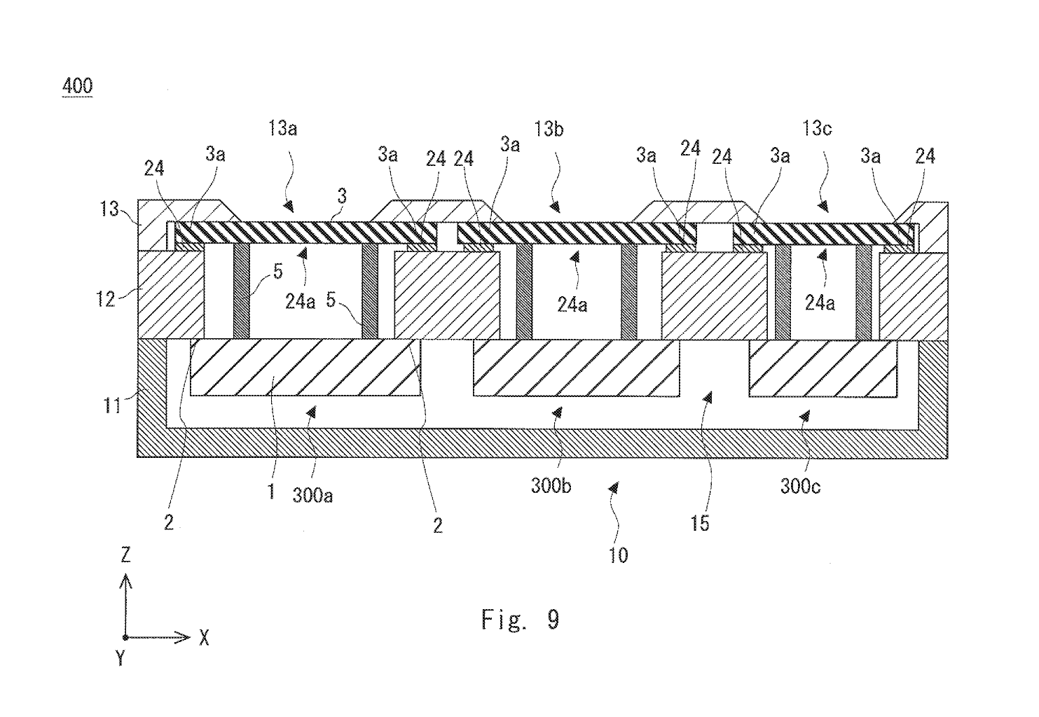

Next, a piezoelectric speaker 400 using the vibration transfer structure 300 is explained with reference to FIG. 9. FIG. 9 is a cross section schematically showing a structure of the piezoelectric speaker 400. In this embodiment, three vibration transfer structures 300 each of which has the structure shown in FIG. 8 are used. Note that similar to FIG. 6, these vibration transfer structures 300, each of which has the structure shown in FIG. 8, are referred to as vibration transfer structures 300a, 300b and 300c, respectively. Note that the structure of each of the vibration transfer structures 300a to 300c is similar to that shown in FIG. 8 and therefore its explanation is omitted. Further, the fundamental structure of the piezoelectric speaker 400 is similar to that of the piezoelectric speaker 200 shown in FIG. 6 and therefore its explanation is omitted.

The elastic body 24 is double-faced tape. As shown in FIG. 9, one of the adhesive surfaces of the elastic body 24 is stuck to the peripheral 3a of the diaphragm 3 and the other adhesive surface of the elastic body 24 is stuck to the frame 12. The peripheral 3a of the diaphragm 3 is fixed to the frame 12 with the elastic body 24 interposed therebetween.

An opening 24a is formed in the central part of each of the elastic bodies 24. Two spacers 5 are disposed in one opening 24a. The spacers 5 are attached to the diaphragm 3 through the opening 24a. For example, the spacers 5 and the diaphragm 3 may be joined to each other with an adhesive or the like interposed therebetween. In the vibration transfer structures 300a to 300c, since the sizes of the diaphragms 3 and the piezoelectric devices 1 differ from one another, the sizes of the elastic bodies 24 and the openings 24a also differ from one another.

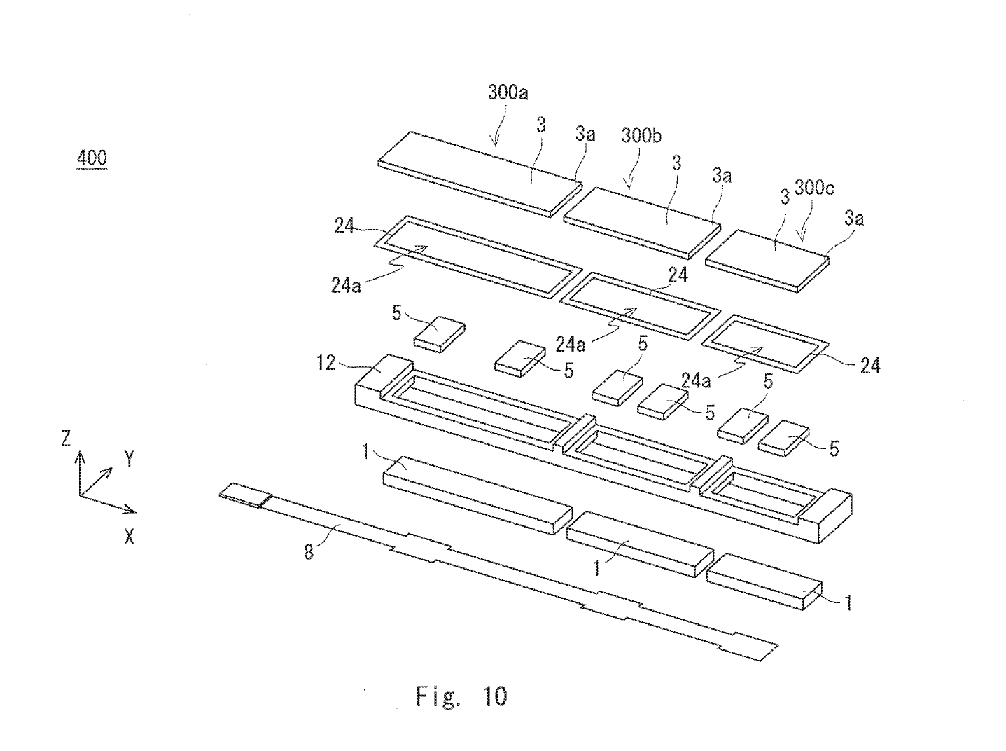

FIG. 10 shows a structure of an example of the piezoelectric speaker 400. FIG. 10 is an exploded perspective view showing an internal structure of the piezoelectric speaker 400. Similarly to the structure shown in FIG. 9, the structure shown in FIG. 10 includes three vibration transfer structures 300a to 300c. Further, the vibration transfer structures 300a to 300c have different sizes from one another. For example, the size of the piezoelectric device 1 of the vibration transfer structure 300a is 21 mm×4 mm The size of the piezoelectric device 1 of the vibration transfer structure 300b is 16 mm×4 mm The size of the piezoelectric device 1 of the vibration transfer structure 300c is 12 mm×4 mm Note that the thickness of all the piezoelectric devices 1 is 1.1 mm.

As shown in FIG. 10, spacers 5 are disposed between the plate-like piezoelectric device 1 and the diaphragm 3. The piezoelectric device 1 and the diaphragm 3 are connected to each other by the spacers 5. Note that the three piezoelectric devices 1 are connected to an FPC (Flexible Printed Circuits) 8. The FPC 8 supplies electric signals to the piezoelectric devices 1.

Further, an elastic body 24 having a rectangular frame shape is stuck to the peripheral 3a of the diaphragm 3. The elastic body 24 is, for example, two pieces of double-faced tape piled on each other. Note that the elastic body 24 is formed in a closed rectangular frame shape so that it can be stuck to the entire perimeter of the peripheral 3a of the diaphragm 3. However, the elastic body 24 does not necessarily have to be stuck to the entire perimeter of the peripheral 3a. For example, no elastic body 24 may be stuck to a part of the peripheral 3a.

The diaphragm 3 and the frame 12 are formed by, for example, SUS. Further, the elastic body 24 fixes the elastic body 24 to the frame 12. Further, the frame 12 has openings corresponding to respective vibration transfer structures 300. The frame 12 supports the piezoelectric device 1 at both ends thereof. For example, both ends of the piezoelectric device 1 are fixed to the surface on the negative side in the Z-direction of the frame 12.

In this way, it is possible to reduce the harmonic distortion as in the case of the second embodiment. By using a plurality of vibration transfer structures 300, it is possible to make the piezoelectric speaker operate in a wide-band. That is, by using a plurality of vibration transfer structures 300 having different sizes, it is possible to connect them in a multistage manner while shifting their resonant frequencies in the first-order mode from one another.

The present disclosure has been explained above with the above-described embodiments and examples. However, the present disclosure is not limited to the above-described embodiments and examples, and needless to say, various modifications, corrections, and combinations that can be made by those skilled in the art are also included in the scope of the present disclosure specified in the claims of the present application.

This application is based upon and claims the benefit of priority from Japanese patent application No. 2015-162759, filed on Aug. 20, 2015, the disclosure of which is incorporated herein in its entirety by reference.

### REFERENCE SIGNS LIST

100, 300 VIBRATION TRANSFER STRUCTURE
1 PIEZOELECTRIC DEVICE
2 SUPPORT PART
3 DIAPHRAGM
4 ELASTIC BODY
5 SPACER
10 CASE
11 HOUSING
12 FRAME
13 COVER
13A-13C SOUND EMITTING HOLE
14 FIXING MATERIAL
15 INTERNAL SPACE
24 ELASTIC BODY
24A OPENING
200, 400 PIEZOELECTRIC MICROPHONE

1. A vibration transfer structure comprising:
a plate-like piezoelectric device supported at both ends thereof;
a diaphragm disposed to be opposed to the piezoelectric device;
a plurality of spacers configured to connect the diaphragm with the piezoelectric device; and
an elastic body disposed on a periphery of the diaphragm.

2. A vibration transfer structure comprising:
a plate-like piezoelectric device supported at both ends thereof;
an elastic body disposed to be opposed to the piezoelectric device;
a diaphragm disposed on a surface of the elastic body opposite to a side on which the piezoelectric device is located; and
a plurality of spacers disposed between the piezoelectric device and the elastic body, the plurality of spacers being adapted to transfer a vibration between the piezoelectric device and the elastic body.

3. The vibration transfer structure according to claim 1, wherein the plurality of spacers are disposed in places that are deviated from a center of the piezoelectric device.

4. The vibration transfer structure according to claim 1, wherein the plurality of spacers comprise:
a first spacer disposed between a center of the piezoelectric device and one of the supported ends of the piezoelectric device; and
a second spacer disposed between the center of the piezoelectric device and the other supported end of the piezoelectric device.

5. The vibration transfer structure according to claim 1, wherein the plurality of spacers are plate-like members disposed along the supported ends of the piezoelectric device.

6. A piezoelectric speaker comprising:
a vibration transfer structure according to claim 1;
a housing configured to accommodate the vibration transfer structure; and
a cover with a sound emitting hole having a horn shape formed therein, the cover being configured to cover the housing, wherein
the diaphragm is disposed so as to overlap the sound emitting hole.

7. The piezoelectric speaker according to claim 6, wherein
the piezoelectric speaker comprises a plurality of vibration transfer structures and a plurality of sound emitting holes, and
the plurality of vibration transfer structures are accommodated in the housing.

8. The vibration transfer structure according to claim 2, wherein the plurality of spacers are disposed in places that are deviated from a center of the piezoelectric device.

9. The vibration transfer structure according to claim 2, wherein the plurality of spacers comprise:
a first spacer disposed between a center of the piezoelectric device and one of the supported ends of the piezoelectric device; and
a second spacer disposed between the center of the piezoelectric device and the other supported end of the piezoelectric device.

10. The vibration transfer structure according to claim 2, wherein the plurality of spacers are plate-like members disposed along the supported ends of the piezoelectric device.

11. A piezoelectric speaker comprising:
a vibration transfer structure according to claim 2;
a housing configured to accommodate the vibration transfer structure; and
a cover with a sound emitting hole having a horn shape formed therein, the cover being configured to cover the housing, wherein
the diaphragm is disposed so as to overlap the sound emitting hole.

12. The piezoelectric speaker according to claim 11, wherein
the piezoelectric speaker comprises a plurality of vibration transfer structures and a plurality of sound emitting holes, and
the plurality of vibration transfer structures are accommodated in the housing.

13. The vibration transfer structure according to claim 1, further comprising;
a first support parts that supports one end of the plate-like piezoelectric device, and
a second support parts that supports the other end of the plate-like piezoelectric device.

14. The vibration transfer structure according to claim 2, further comprising:
a first support parts that supports one end of the plate-like piezoelectric device; and
a second support parts that supports the other end of the plate-like piezoelectric device.
